(19) United States
(12) Patent Application Publication
(10) Pub. No.: US 2016/0010732 A1
(43) Pub. Date: Jan. 14, 2016

(54) TRANSMISSION

(71) Applicant: JERRY BLEVINS, Toms Brook, VA (US)

(72) Inventor: JERRY BLEVINS, Toms Brook, VA (US)

(21) Appl. No.: 14/328,111

(22) Filed: Jul. 10, 2014

(51) Int. Cl. F16H 37/04; F16H 55/00

(52) U.S. Cl. CPC F16H 37/041; F16H 55/00

(57) ABSTRACT

A device transferring force to assist in the rotation of an axle or shaft is disclosed. A driveshaft through a belt, gearing or a chain is used to rotate a wheel having a plurality of vanes or moment arms provided within the interior of the wheel. One end of each of the vanes is connected to a gearing mechanism. Rotation of the wheel and therefore the vanes or moment arms results in rotation of gears provided in the gearing mechanism. The gearing mechanism is in turn connected to a shaft causing rotation of the shaft.

### CROSS REFERENCE TO RELATED APPLICATION

This application claims the benefit of U.S. Provisional Patent Application Ser. No. 61/845,030, filed Jul. 11, 2013, entitled “TRANSMISSION.”

### FIELD OF THE INVENTION

The present invention is directed to a method and system for applying force to turn a wheel which in turns assists in the rotation of a shaft.

### BACKGROUND OF THE INVENTION

A transmission, particularly used in motor vehicles, adapts the output of the internal combustion engine to rotate the wheels of the motor vehicle. These internal combustion engines need to operate at a relatively high rotation speed, which is inappropriate for starting, stopping and slower travel. The transmission reduces the higher engine speed to a slower engine speed, thereby increasing torque in the process. Various transmissions can also be used on pedal bicycles, or various machines, in any situation where torque must be adapted. Often, a transmission has multiple gear ratios with the ability to switch between gears as speed varies. Switching may be done manually or automatically. Directional control may also be provided. Single-ratio transmissions simply change the speed and torque and sometimes the direction of the motor output. When used in motor vehicles, the internal combustion engine is generally connected to the engine's crankshaft and flywheel by a fluid coupling. The output of the transmission is transmitted by a driveshaft to one or more differentials, which in turn drive the front and rear wheels. While a differential may also provide a gear reduction, its primary purpose is to prevent the wheels at either end of the rear axle to rotate at different speeds which is essential to avoid wheel slippage on turns, as it changes the direction of rotation.

In most situations, particularly when the engine driveshaft is connected to the differential used in respect to the rear axle, the utilization of a rotating wheel close to the differential would maintain or increase the speed of the axle as it rotates.

### SUMMARY OF THE INVENTION

The deficiencies of the prior art are addressed by the present invention in which a force is applied by a longitudinal shaft to turn a wheel connected to a gear box to in turn rotate an axle which in turn rotates a wheel when utilized in conjunction with a motor vehicle. Additionally, the rotation of the wheel can be utilized to increase the speed of a shaft connected to virtually any output device.

It is therefore an object of the present invention to produce a transmission device in which force is applied to a gear box with the purpose of maintaining or increasing the rotational speed of a shaft. It is a further object of the present invention to produce a device for maintaining or increasing the speed of both the front and rear axles of a motor vehicle.

It is a further object of the present invention to utilize the rotation of the shaft connected to an alternator or a generator of any vehicle to produce electrical energy as well as to charge a battery.

It is, therefore, an object of the present invention to provide a force transmission device including a rotating wheel including a plurality of vanes and a gear box. Each of the vanes includes a first end fixedly connected to an interior surface of the rotating wheel and a second end connected to a central rotary input hub of the gear box.

It is also an object of the present invention to provide a force transmission device wherein the gear box includes a planetary gear assembly.

It is another object of the present invention to provide a force transmission device including a driveshaft in a driving relationship with the rotating wheel.

It is a further object of the present invention to provide a force transmission device wherein the driveshaft drives a belt that drives the rotating wheel.

It is also an object of the present invention to provide a force transmission device wherein the driveshaft drives a gear which engages teeth on an exterior surface of the rotating wheel.

It is another object of the present invention to provide a force transmission device including an electric motor driving the driveshaft.

It is a further object of the present invention to provide a force transmission device including a secondary electric motor/gear box for driving the rotating wheel.

It is also an object of the present invention to provide a force transmission device including a differential and axle to which an output drive of the gear box is connected in a driving relationship.

It is another object of the present invention to provide a force transmission device wherein the gear box drives a shaft that drives gears acting upon a tooth surface of a wheel.

It is a further object of the present invention to provide a force transmission device wherein the force transmission device powers a helicopter blade.

It is also an object of the present invention to provide a force transmission device wherein the force transmission device powers an airplane propeller.

It is another object of the present invention to provide a force transmission device wherein the force transmitting device powers a marine propeller.

It is a further object of the present invention to provide a force transmission device wherein the force transmitting device powers an alternator or generator.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view showing the force transmission device of the present invention connected to a gear box.

FIG. 2 is a perspective view of a force transmission device in accordance with the present invention provided on top of a differential.

FIG. 3 is a perspective view of a force transmission device in accordance with the present invention powered by a belt, gear or chain.

FIG. 4 is a detailed perspective view of the force transmission device shown in FIG. 2.

FIG. 5 is a perspective view of the force transmission device shown in FIG. 2 utilizing a chain driven mechanism.

FIG. 6 is a detailed perspective view of a typical gear box provided with planetary gearing and as employed in accordance with the present invention.

FIG. 7 is a perspective view of an alternate force transmission device in accordance with the present invention showing the driveshaft rotating the wheel.

FIG. 8 is a perspective view of the force transmission device shown in FIG. 7 but directly connected to the differential.

FIG. 9 is a detailed perspective view showing the connection of the gear box to the differential.

FIG. 10 is a view showing a force transmission device in accordance with the present invention powered by gear, electric motor, chain or belt.

FIG. 11 is a view of the force transmission device being powered by a chain or belt in accordance with an alternate embodiment.

FIG. 12 is a perspective view of the force transmission device in accordance with the present invention used to rotate a helicopter propeller.

FIG. 13 is a perspective view of the force transmission device in accordance with the present invention used to power a propeller of an airplane.

FIG. 14 is a perspective view of the force transmission device in accordance with the present invention used to power a boat propeller.

FIG. 15 is a perspective view of the force transmission device in accordance with the present invention connected to an alternator or generator.

FIG. 16 is a perspective view of the force transmission device in accordance with the present invention connected to an air conditioning unit.

### DETAILED DESCRIPTION OF THE PRESENT INVENTION

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

The present force transmission device operates when a force is applied to turn a relatively large wheel which in turn is connected to a gear box to maintain or increase the speed of a shaft to which the gear box is connected. When the gear box is connected to the front or rear axle of an automobile, a shaft would rotate, causing the rotation of the wheels provided at either end of the shaft. However, it is noted that the wheel can be mounted on any mechanical device that rolls or turns such as automobiles, locomotives, boats, planes, bikes, tractors, alternators, generators, motors and air conditioning units. It is further appreciated the present force transmission device may be used in conjunction with gas, oil, natural gas, diesel and any other fossil fuel powered vehicles. The gears within the gear box initially powered can be powered by humans, animals, gas power, water power, air power as well as by electric and gas motors. The large wheel can be mounted in all directions, such as vertical, horizontal or any angle there between.

It should be appreciated that although multiple embodiments are disclosed in conjunction with the disclosure of the present invention, similar reference numerals are used where similarities in function and structure allow.

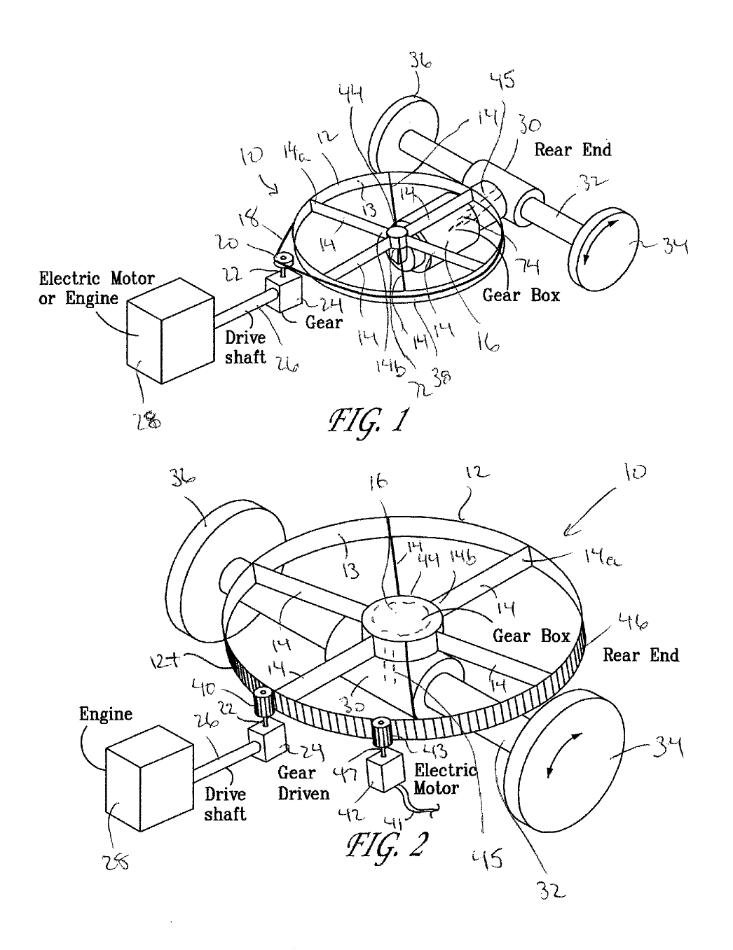

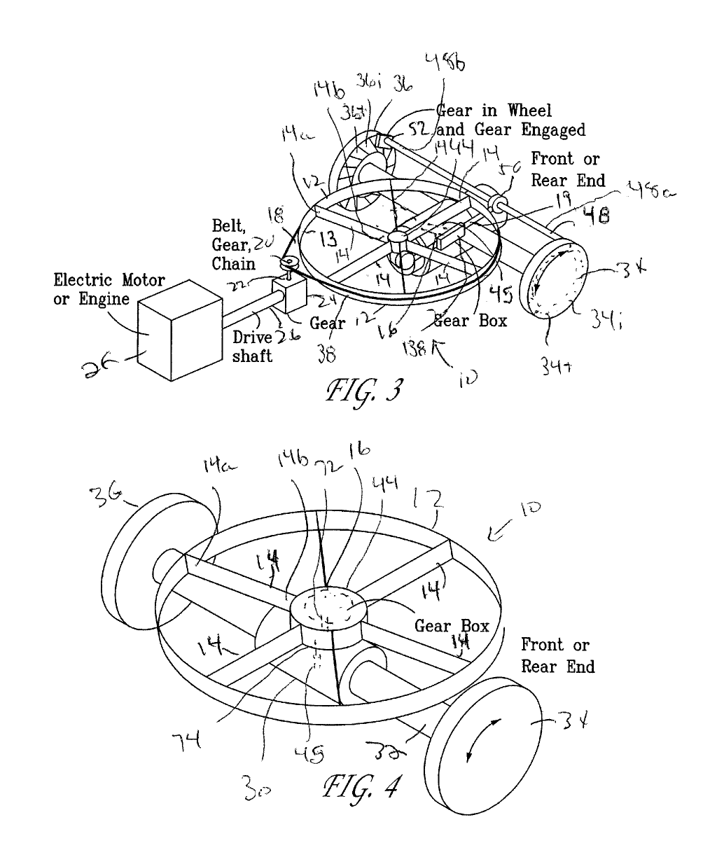

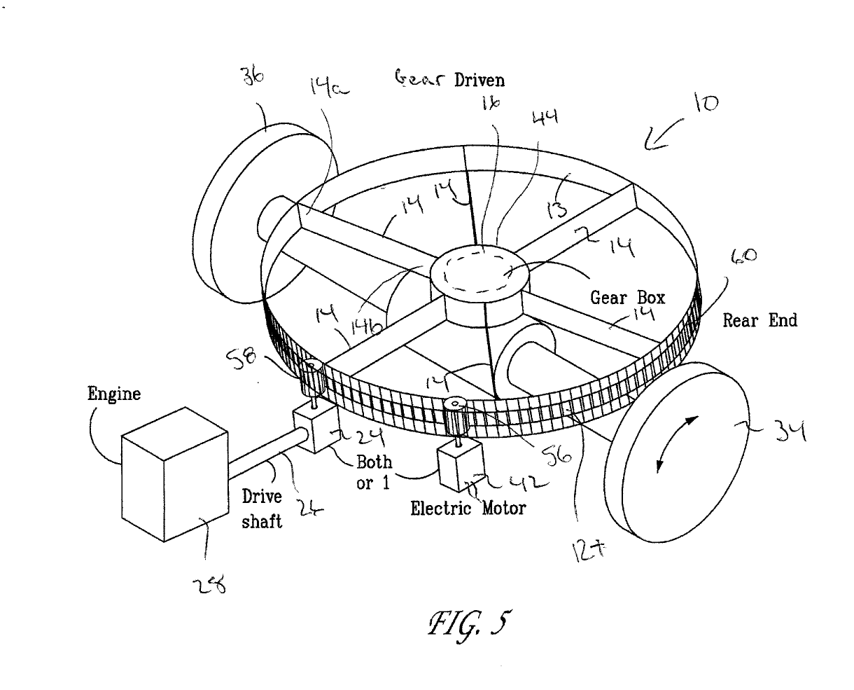

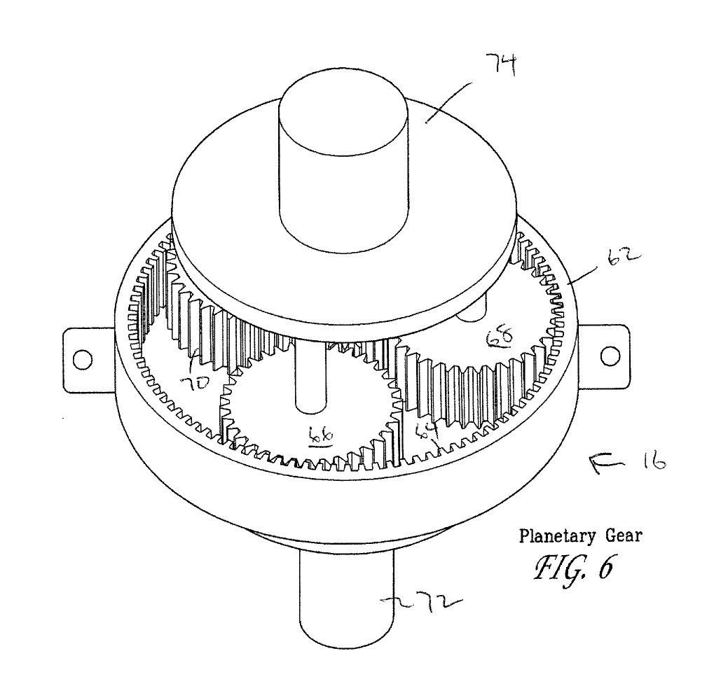

More particularly, and with reference to FIGS. 1-5, the present force transmission device is illustrated in various configurations as it would be applied to the front or rear axles of a motor vehicle. For example, FIG. 1 shows the force transmission device 10 connected to a gear box 16 which is ultimately connected in a manner driving a rear differential 30 causing the rotation of an axle 32, and resulting in the movement of wheels 34 and 36. FIGS. 2 and 4 show a similar arrangement wherein the force transmission device 10 is positioned on top of the differential 30. FIG. 3 shows the force transmission device 10 as it would be constructed where the rotating wheel 12 is powered by a belt, gear or chain 18. FIG. 5 is a perspective view of the force transmission device 10 shown in FIG. 2 utilizing a chain driven mechanism. It is noted that although FIGS. 1-5 show the rotation of the rear axle 32 of a motor vehicle, the rotating wheel 12 can be constructed to cause the rotation of the front axle differential of the motor vehicle. The revolution of the rotating wheel 12 produces a force multiplied by the gears in the gear box 16 which are applied to the axle 32.

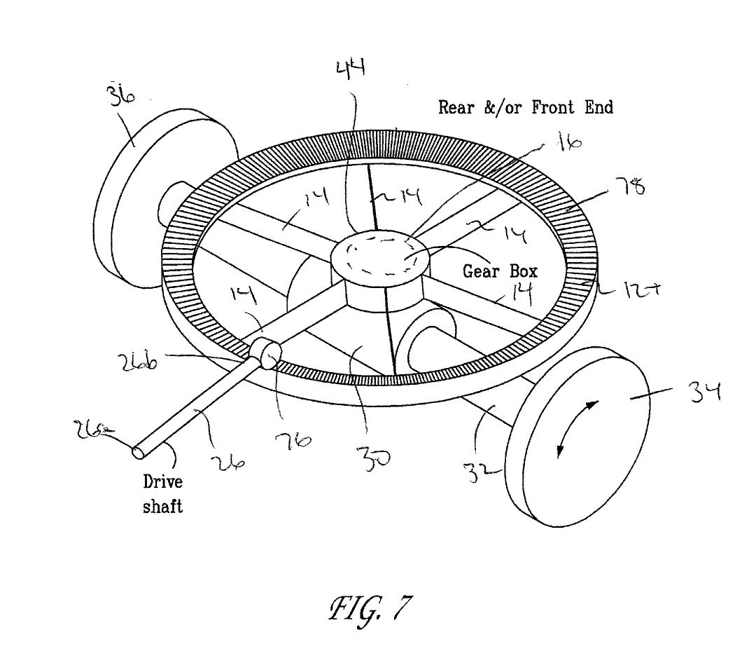

Regardless of the manner in which it is employed, the force transmission device 10 includes a rotating wheel 12 provided with a plurality of vanes or moment arms 14 extending from a central rotary input hub 44 of the gear box 16 and positioned within the space defined by the rotating wheel 12. One end (a first end) 14a of each of the vanes 14 is fixedly connected to the interior surface 13 of the rotating wheel 12. The second end 14b of each of the vanes 14 is fixedly connected to a central rotary input hub 44 of the gear box 16. Therefore, rotation of the rotating wheel 12 causes the vanes or moment arms 14 to rotate which in turn rotates the central rotary input hub 44 of the gear box 16 to rotate the gears provided within the gear box 16. As explained below with reference to FIG. 6, the gear box 16 employs a conventional planetary gear assembly 62, although it is appreciated other gearing assemblies may be employed without departing from the spirit of the present invention.

FIG. 1 illustrates one manner of rotating the rotating wheel 12 of the force transmission device 10. As shown therein, an electric motor or engine 28 is connected to a longitudinally rotating driveshaft 26. The driveshaft 26 is in turn connected to a gear box 24. It is appreciated the gear box employed in accordance with the present invention is of a conventional design known to those skilled in the art, and various gear boxes may be employed in accordance with the present invention without departing from the spirit of the present invention. The longitudinal rotation of the driveshaft 26 causes gears within the gear box 24 to rotate. This rotation of the gears within the gear box 24 causes rotation of a shaft 22 which in turn is connected to and causes the rotation of a spindle 20. A belt 18 is connected to the rotating spindle 20 as well as the exterior surface 15 of the rotating wheel 12, to thereby connect the rotating spindle 20 and the rotating wheel 12 in a driving relationship. Therefore, the rotation of the driveshaft 26 results in the rotation of the spindle 20. The rotation of the spindle 20 causes the belt 18 to move which results in the rotation of the rotating wheel 12. Rotation of the rotating wheel 12 in turn causes rotation of the central rotary input hub 44 of the gear box 16 causing rotation of the gears provided within the gear box 16. The output drive 45 of the gear box 16 is connected to a rear differential 30 causing the rotation of an axle 32, resulting in the movement of wheels 34 and 36.

FIGS. 2 and 4 illustrate a second embodiment of the present invention where a gear box 16 is mounted directly on top of the differential 30. Similar to the embodiment illustrated in FIG. 1, the embodiment shown in FIGS. 2 and 4 includes a rotating wheel 12 rotated by longitudinal rotation of the driveshaft 26 causing rotation of the central rotary input hub 44 of the gear box 16 which in turn drives the gears within the gear box 16 to rotate. The output drive 45 of the gear box 16 is connected to the differential 30 which in turn results in the rotation of the axle or shaft 32. It is appreciated the connection of these elements is conventional and may be accomplished in various ways by those skilled in the art.

In contrast to the embodiment disclosed with reference to FIG. 1 which employs a belt 18 for driving the rotating wheel 12, the embodiment of the FIG. 2 employs a gear box 24 including a rotating shaft 22 causing a gear 40 to rotate and directly engage the rotating wheel 12. More particularly, the outside surface 46 of the rotating wheel 12 is provided with a plurality of teeth 12t. Therefore, and when the gear 40 is engaged with the outside surface 46 of the rotating wheel 12, the rotation of the gear 40 in cooperation with the teeth 12t provided on the exterior surface 46 of the rotating wheel 12 results in the rotation of the rotating wheel 12, causing the rotation of the vanes 14 which in turn results in the rotation of the central rotary input hub 44 of the gear box 16 which in turn drives the gears within the gear box 16 to rotate. This rotation is output to an output shaft 45 of the gear box 16 utilized to rotate the differential 30 and therefore the shaft or axle 32.

It is appreciated the applied force of engine 28 may be supplemented with a supplemental drive assemblies. As shown in FIG. 2, a secondary electric motor/gear box 42 provided with wiring 41 for receiving a supply of electrical power may be engaged with the rotating wheel 12 via a second gear 43. The secondary electric motor/gear box 42 causes a shaft 47 to rotate resulting in the rotation of a second gear 43, which acts to apply rotational force to the wheel. As can be appreciated, the electric motor can be utilized to power additional gear boxes which in turn would cause rotation of additional gears to help rotate the rotating wheel 12.

FIG. 3 illustrates a third embodiment of the present invention which utilizes a belt, gear or chain 18 to cause the rotation of the rotating wheel 12 as discussed above with reference to the embodiment of FIG. 1. In accordance with this embodiment, rotation of the rotating wheel 12 causes the rotation of an additional shaft 48 provided between the wheels 34 and 36. The inside surface 34i, 36i of each of the wheels 34 and 36 is provided with a plurality of teeth 34t, 36t. Each end 48a, 48b of the shaft 48 is provided with a gear 52 cooperating with the tooth surface along the respective inside surfaces 34i, 36i of the wheels 34 and 36, assisting in the rotation of each of the wheels 34 and 36.

As with the embodiment disclosed with reference to FIG. 1, rotation of the vanes or moment arms 14 causes rotation of the central rotary input hub 44 of the gear box 16 which in turn drives the gears within the gear box 16 to rotate. Rather than being connected to a differential as disclosed with reference to FIG. 1, the output drive 45 of the gear box 16 is connected in a driving relationship with a second gear box 138. The output drive 45 of the gear box 16 causes the gears within the second gear box 138 to rotate a shaft 19 connected to the shaft 48 for driving the same. In this way, rotation of the rotating wheel 12 drives the central rotary input hub 44, which drives the output drive 45 of the gear box 16, which drives a second gear box 138, which ultimately drives the shaft 48 and the wheels 34, 36.

FIG. 5 illustrates a fourth embodiment of the present invention showing the use of both the gear box 24 as well as an electric motor causing a secondary electric motor/gear box 42 to rotate. The rotation of each of the gear boxes 16, 42 causes the rotation of gears 56 and 58 similar to the embodiment shown in FIG. 2. As shown in FIG. 5, the interior surface 60 of the rotating wheel 12 includes a plurality of teeth 12t cooperating with the gears 56 and 58 rotating on the interior surface 60 of the rotating wheel 12 causing the rotation of the vanes or moment arms 14 connected to the gear box 16. As with the embodiment disclosed with reference to FIG. 2, this embodiment employs a gear mechanism for the driving of the rotating wheel 12.

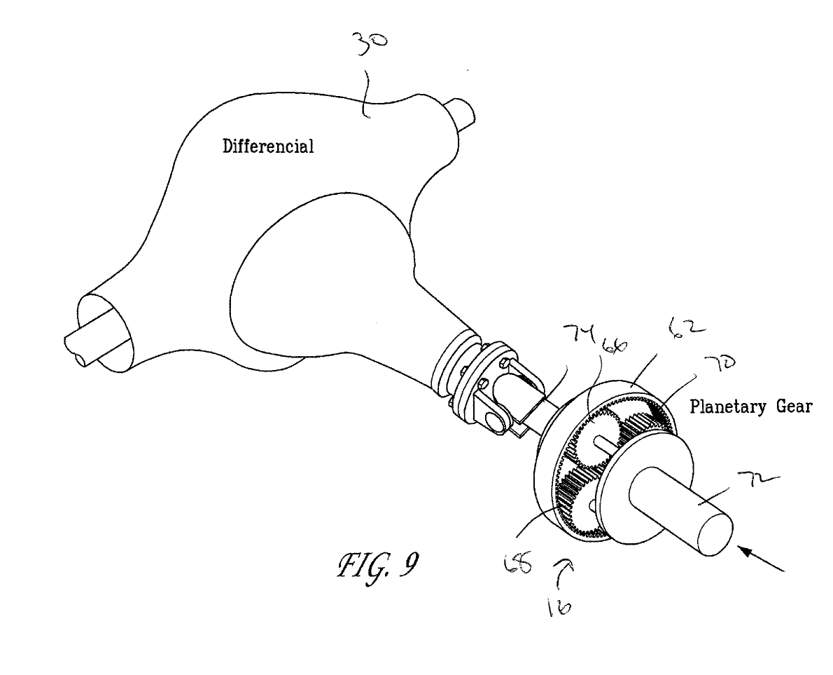

FIG. 6 shows a typical gear box 16 used in accordance with the various embodiments disclosed herein. As discussed above, this gear box 16 is to be connected to the differential 30 (which is also shown as FIG. 9), or other force transmitting mechanisms as contemplated in the various embodiments, using conventional connection techniques. The gear box 16 is a planetary gear assembly 62 includes a input shaft 72 (upon which the central rotary input hub 44 is mounted) which rotates based upon the rotation of the rotating wheel 12 as well as a shaft 74 (upon which the output drive 45 is mounted) connected to the differential 30), or other force transmitting mechanisms as contemplated in the various embodiments, using conventional connection techniques. As shown in FIG. 6, the planetary gear includes a plurality of teeth 64 provided on the inside surface of the planetary gear box. The rotation of the planetary gear 66, 68 and 70 results in the rotation of the shaft 74 connected to the differential, or other force transmitting mechanisms as contemplated in the various embodiments, used to assist in the rotation of the axle 32 or other driving member. It is appreciated the planetary gear assembly employed in accordance with the present invention is of a conventional design known to those skilled in the art, and various assemblies may be employed in accordance with the present invention without departing from the spirit of the present invention.

FIG. 7 illustrates an alternate embodiment utilizing the driveshaft 26 of the motor vehicle to cause rotation of a rotating wheel 12 having vanes 14 connected therefrom in a manner similar to which the vanes or moment arms 14 are connected in FIG. 1. However, and in contrast to the embodiment disclosed with reference to FIG. 1, the top surface 78 of the rotating wheel 12 is provided with a plurality of teeth 12t. The first end 26a of the driveshaft 26 is driven in a manner similar to that disclosed with reference to FIG. 1, but the second end 26b of the driveshaft 26 includes gearing 76 shaped and dimensioned for engagement with the top surface 78 of the rotating wheel 12 to cause movement thereof. In this way, the rotation of the driveshaft 26 causes the rotation of the gearing 76 at the second end 26b of the driveshaft, which cooperates with the tooth surface 78 of the rotating wheel 12. This results in the rotation of the wheel 78 and consequently the rotation of the shaft of the vanes or moment arms 14 which are connected to the central rotary input hub 44 of the gear box 16 which in turn drives the gears within the gear box 16 to drive the differential 30 and the wheels 34, 36. Therefore, rotation of the gears within the gear box 16 would cause the rotation of the differential 30 and consequently the axle 32 and the wheels 34 and 36.

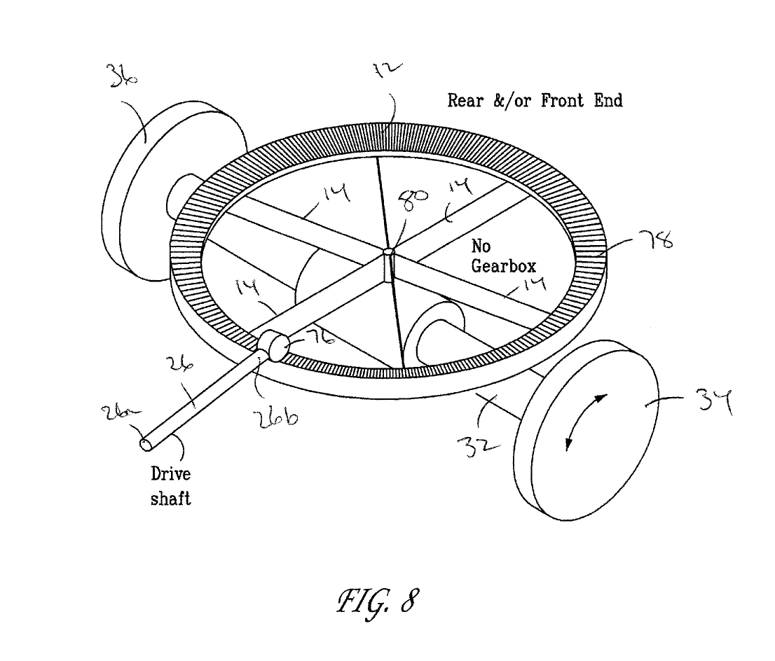

FIG. 8 shows an embodiment which does not include the gear box 16. A shaft 80 is connected to the second end 14b of the vanes 14. Shaft 80 is also connected to the differential 30. Therefore, rotation of the rotating wheel 12 causes the rotation of the vanes 14. The vanes 14 result in the rotation of the shaft 80 and ultimately the rotation of the axle 32.

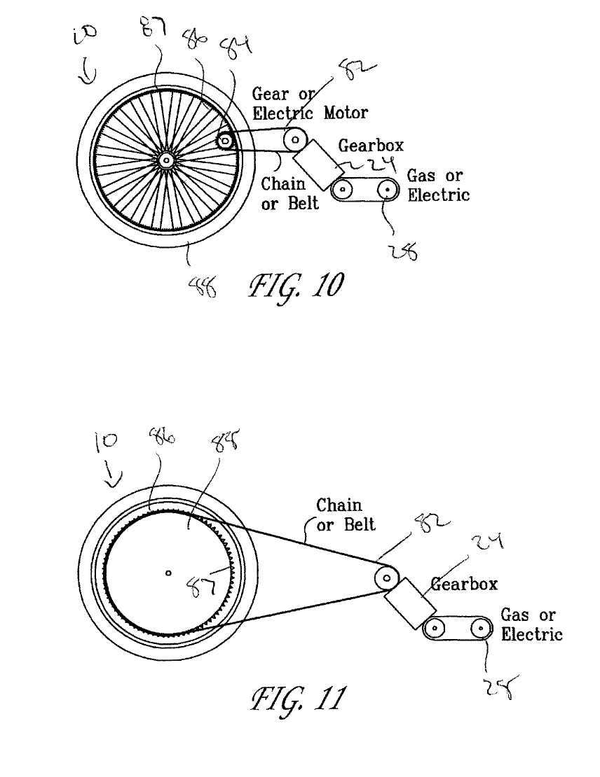

FIGS. 10 and 11 illustrate mechanisms utilizing a gear, chain or belt to rotate a rotating wheel 12 via the power provided by a motor 28. As shown in FIG. 10, a gear 84 connected to a chain or belt 82 causing the rotation of a gear or chain 84 which in turn causes rotation of a tooth gear 86 provided on the interior surface 87 of the wheel 88. The rotational power is provided via the motor 28 acting upon a gear box 24 which in turn acts upon the gear or chain 84. FIG. 11 includes a chain or belt 82 cooperating with the inside surface 87 of the wheel 88 used to cause rotation of the wheel 88 similar to the rotation illustrated with respect to FIGS. 1-5. As with the embodiment in FIG. 10, the rotational power is provided via the motor 28 acting upon a gear box 24 which in turn acts upon the gear or chain 84.

The embodiments illustrated in FIG. 1-11 generally show the use of a horizontal wheel. As previously indicated, a wheel can be vertically mounted or at any angle between the vertical and the horizontal.

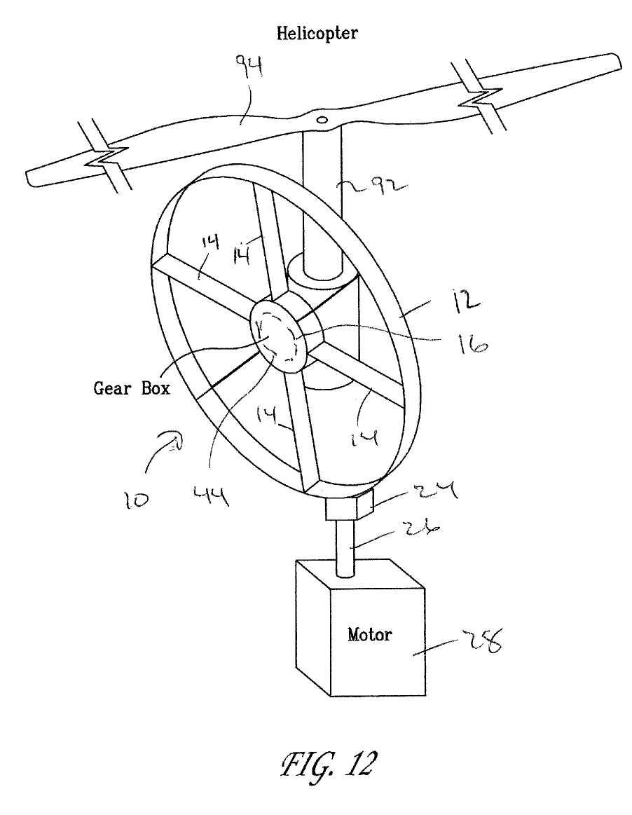

FIGS. 12-16 show various implementations of the present force transmission device. FIG. 12 shows the use of the vertically oriented rotating wheel 12 connected to a motor 28, a driveshaft 26 as well as gear box 24 causing the rotation of the rotating wheel 12. The rotation of the rotating wheel 12 forces the vanes 14 to rotate, which in turn drives the central rotary input hub 44 of the gear box 16 to drives the gears within the gear box 16. This results in the rotation of an upstanding shaft 92 which in turn causes the rotation of a helicopter blade 94.

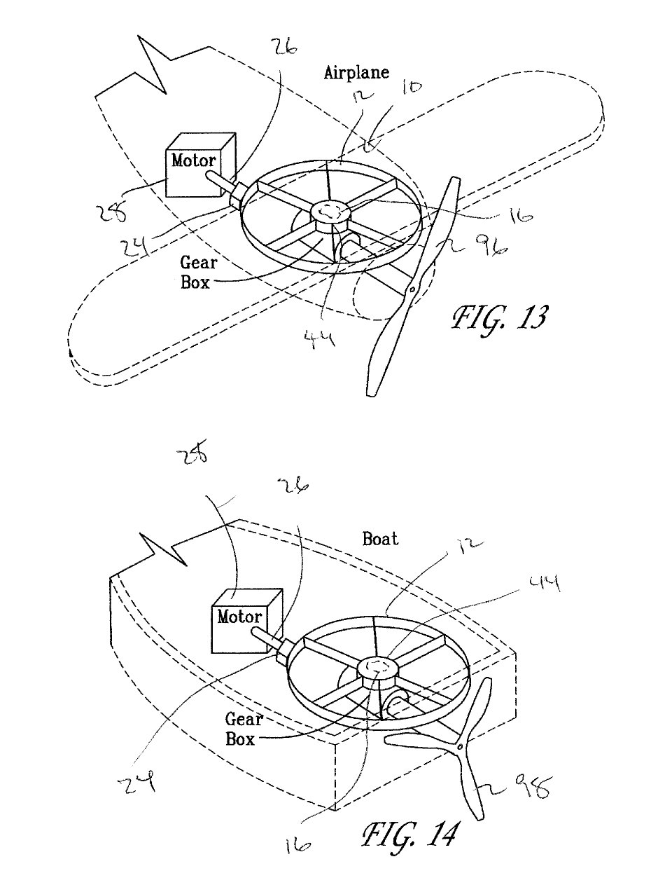

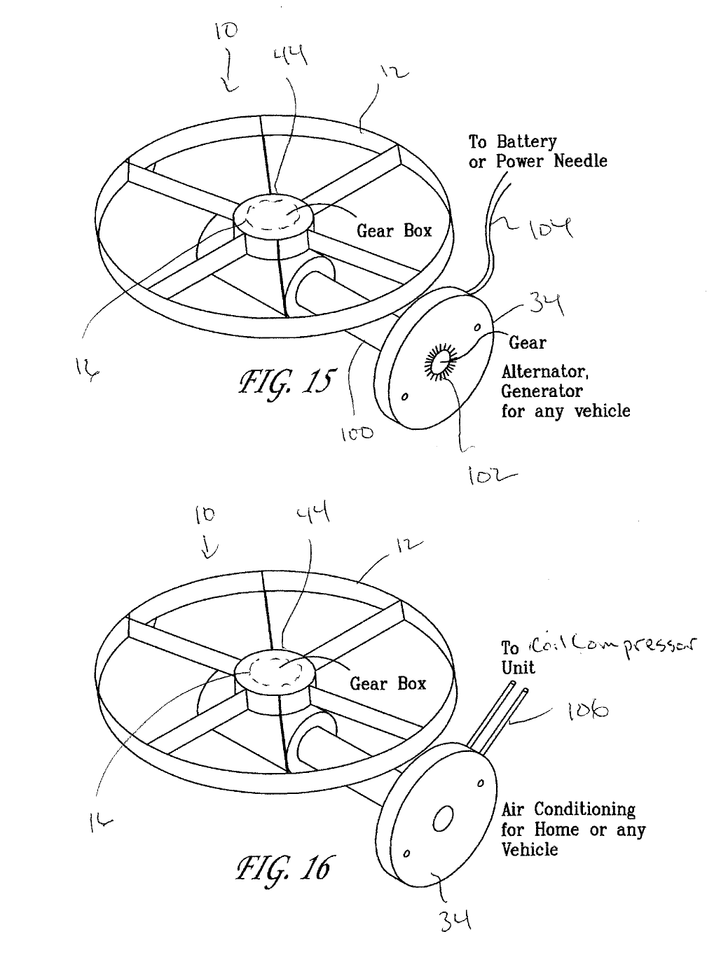

FIG. 13 illustrates the use of a horizontally configured rotating wheel 12 used to power airplane propeller 96. FIG. 14 shows use of the horizontally fixed rotating wheel 12 causing rotation of a marine propeller 98 via the central rotary input hub 44 and the gears within the gear box 16. FIG. 15 illustrates that the rotation of the rotating wheel 12 causes rotation of a shaft 100 due to rotation of the vanes 14, the central rotary input hub 44 and the gears within the gear box 16. A gear 102 connected to wheel 34 can be in turn connected to the alternator or generator of any vehicle. Additionally, the rotation of the wheel 34 can produce electrical energy transmitted to the battery with the use of electric wires 104. FIG. 16 shows the use of the rotation of the wheel 34 connected to a coil compressor of an air conditioning unit of a home or any vehicle through electrical wires 106.

As described and illustrated in the present application, power from the gear boxes caused by the rotation of the wheel can be applied to an axle provided in an automobile, marine vehicle, airplane, tractor, or any vehicle included a rotating axle or shaft in various manners. For example, the rotation of the gears provided in the gear box is directly connected to the axle or shaft. Alternatively, the gears in the gear box are connected to a differential provided on the axle or shaft. Additionally, rotation of the gears in the gear box is the result of the rotation of additional gears located outside of the gear box. The gears located outside of the gear box utilize various mechanical connections, such as a chain, a belt with or without pulleys, or a combination of these devices to rotate the wheel, which in turn causes the gears in the gear box to rotate, and ultimately causing the axle or shaft to rotate.

1. A force transmission device, comprising:
a rotating wheel including a plurality of vanes;
a gear box;
each of the plurality of vanes including a first end fixedly connected to an interior surface of the rotating wheel and a second end connected to a central rotary input hub of the gear box.

2. The force transmission device according to claim 1, wherein the gear box includes a planetary gear assembly.

3. The force transmission device according to claim 1, further including a driveshaft in a driving relationship with the rotating wheel.

4. The force transmission device according to claim 3, wherein the drivershaft drives a belt that drives the rotating wheel.

5. The force transmission device according to claim 3, wherein the driveshaft drives a gear which engages teeth on an exterior surface of the rotating wheel.

6. The force transmission device according to claim 3, further including an electric motor driving the driveshaft.

7. The force transmission device according to claim 3, further including a secondary electric motor/gear box for driving the rotating wheel.

8. The force transmission device according to claim 1, further including a differential and axle to which an output drive of the gear box is connected in a driving relationship.

9. The force transmission device according to claim 1, wherein the gear box drives a shaft that drives gears acting upon a tooth surface of a wheel.

10. The force transmission device according to claim 1, wherein the force transmission device powers a helicopter blade.

11. The force transmission device according to claim 1, wherein the force transmission device powers an airplane propeller.

12. The force transmission device according to claim 1, wherein the force transmitting device powers a marine propeller.

13. The force transmission device according to claim 1, wherein the force transmitting device powers an alternator or generator.
